(19) United States
(12) Patent Application Publication
(10) Pub. No.: US 2012/0179543 A1
(43) Pub. Date: Jul. 12, 2012

(54) Targeted advertisement

(76) Inventors: Huitao Luo, Fremont, CA (US); Ben Slutter, San Francisco, CA (US); Chun Han, Sunnyvale, CA (US); Nanda Kishore, Los Altos, CA (US); Aparna Seetharaman, Palo Alto, CA (US)

(21) Appl. No.: 12/930,477

(22) Filed: Jan. 7, 2011

(51) Int. Cl. G06Q 30/00; G06F 17/30

(52) U.S. Cl. 705/14.54; 705/14.53; 707/769; 707/E17.014

(57) ABSTRACT

The present invention provides a method and a system for providing targeted advertisements to a user. The method includes determining a set of signals corresponding to at least one online activity associated with the user and then analyzing the set of signals to identify one or more user interests. The set of signals includes at least one of a share signal, a view signal, a search signal, and a click signal. Further, the method includes tagging the user with at least one ad exchange cookie based on the identified user interests and an available advertisement pool. Lastly, the method includes displaying, by an advertisement network, an advertisement to the user based on the ad exchange cookie.

### FIELD OF THE INVENTION

The present invention relates, in general, to online advertisements and, more specifically, to a method, a system, and a computer program product for providing targeted advertisements to users.

### BACKGROUND

Since the advent of the Internet, the number of users accessing websites and using Internet for online transactions, online shopping, social networking, etc., has been increasing constantly. Today, most of the companies around the world understand the Internet's importance and know how it can be used for advertisement purposes. For instance, most of the websites now display targeted advertisement to the users accessing them to gather as much users' “attention” as possible.

Conventionally, targeted advertisement is displayed on a website based on the nature of the website content that the user is currently viewing. For example, if a-user is viewing a sports website, advertisements of companies selling sports goods may be shown to the user. Currently, there is no way by which other details of the users can be used for presenting targeted advertisements to users.

Currently, there is no system by which an advertisement campaign manager planning a “targeted advertisement campaign” can select the users to whom he/she can target for his/her advertisement campaign. For example, currently all the users accessing the above-mentioned sports website will be shown the same advertisement, and the advertisement manager running the advertisement campaign will have no option to “select” a subset of users to which specific advertisements should be shown.

In light of the above, a method and a system is required for targeted advertisements, which can overcome the limitations of the present day methods and systems.

### SUMMARY OF THE INVENTION

According to an embodiment of the present invention, a method for providing targeted advertisements to a user is provided. The method includes determining a set of signals corresponding to at least one online activity associated with the user. The set of signals includes at least one of a share signal, a view signal, a search signal, and a click signal. Further, the method includes analyzing the set of signals to identify one or more user interests. In accordance with an embodiment of the present invention, analyzing the set of signals includes determining one or more keywords present in the set of signals to identify the one or more user interests.

The method includes tagging the user with at least one ad exchange cookie based on the one or more user interests and an available advertisement pool. In accordance with an embodiment of the present invention, the advertisement pool is maintained by an advertisement network. Finally, the method includes serving, by the advertisement network, an advertisement to the user based on the ad exchange cookie.

According to another embodiment of the present invention, a method for analyzing a set of signals to identify one or more user interests corresponding to the user is provided. The method includes identifying at least one of a webpage accessed by the user, a search query input by the user, a click performed by the user on a Uniform Resource Locator (URL), and a data shared by the user, based on information present in the set of signals. Further, the method includes determining one or more keywords present in at least one of the webpage accessed by the user, the search query input by the user, the click performed by the user, and the data shared by the user.

The method includes using an online information source, for example Wikipedia, to analyze the one or more keywords. Lastly, the method includes determining the one or more user interests based on the one or more keywords' analysis.

In accordance with yet another embodiment of the present invention, a method for identifying one or more users from a plurality of users for a predefined targeted advertisement is provided. The method includes analyzing a set of signals associated with the plurality of users. The set of signals includes at least one of a share signal, a view signal, a search signal, and a click signal. In accordance with an embodiment of the present invention, analyzing the set of signals associated with the users comprises identifying one or more keywords present in the set of signals to identify the one or more user interests of the users.

The method includes identifying one or more user interests for a user of the plurality of users based on the analysis of the set of signals. Further, the method includes matching the identified one or more user interests with the predefined targeted advertisement and then determining the one or more users from the plurality of users for the predefined targeted advertisement based on the matching.

According to yet another embodiment of the present invention, a method for allowing an advertisement campaign manager to identify one or more users for targeted advertisements is provided. The method includes providing an online tool to the advertisement campaign manager to allow the advertisement campaign manager to input keywords associated with the targeted advertisements. Further, the method includes using a predefined page level co-occurrence algorithm to determine one or more additional keywords related to the keywords input by the advertisement campaign manager. Further, the method includes providing an option to the advertisement campaign manager to select additional keywords from the determined one or more additional keywords.

The method also includes determining one or more users for targeted advertisement based on the keywords input by the advertisement campaign manager and the selected additional keywords. Lastly, the method includes presenting a list of one or more users to the advertisement campaign manager. In accordance with an embodiment of the present invention, the list of one or more users is divided into one or more sub-groups while the list is being presented to the user. The sub-groups can be, for example, group of influencers, affected users, and potentials.

According to yet another embodiment of the present invention, a system for providing targeted advertisements to a user is provided. The system includes a processor for determining a set of signals corresponding to at least one online activity associated with the user. The set of signals includes at least one of a share signal, a view signal, a search signal, and a click signal. Further, the system includes an analyzer for analyzing the set of signals to identify the one or more user interests. In accordance with an embodiment of the present invention, the analyzer analyzes the set of signals by determining one or more keywords present in the set of signals to identify the one or more user interests.

The system further includes a tagger for tagging the user with at least one ad exchange cookie based on the one or more user interests and an available advertisement pool. Additionally, the system includes an advertisement network module for serving an advertisement to the user based on the ad exchange cookie.

According to yet another embodiment of the present invention, a system for analyzing a set of signals to identify the one or more user interests corresponding to the user is provided. The system includes a processor configured to identify at least one of a webpage accessed by the user, a search query input by the user, a click performed by the user on a Uniform Resource Locator (URL), and a data shared by the user, based on information present in the set of signals. The processor is also configured to determine one or more keywords present in at least one of the webpage accessed by the user, the search query input by the user, the click performed by the user, and the data shared by the user. Further, the processor is configured to determine the one or more user interests based on one or more keywords' analysis.

Additionally, the system includes an analyzer for using an online information source, such as Wikipedia®, to analyze the one or more keywords.

According to yet another embodiment of the present invention, a system for identifying one or more users from a plurality of users for a predefined targeted advertisement is provided. The system includes an analyzer for analyzing a set of signals associated with a user of the plurality of users. The set of signals includes at least one of a share signal, a view signal, a search signal, and a click signal.

The system includes a processor configured to identify one or more user interests for a user of the plurality of users based on the analysis of the set of signals. In addition, the processor is configured to match the identified one or more user interests for the user with the predefined targeted advertisement. Thereafter, based on the matching, the processor determines the one or more users from the plurality of users for the predefined targeted advertisement.

According to yet another embodiment of the present invention, a system for allowing an advertisement campaign manager to identify the one or more users for targeted advertisements is provided. The system includes an online tool to allow the advertisement campaign manager to input keywords associated with the targeted advertisements. Further, the system includes a processor configured to use a predefined page level co-occurrence algorithm to determine one or more additional keywords related to the keywords input by the advertisement campaign manager.

The processor is also configured to provide an option to the advertisement campaign manager to select additional keywords from the keywords determined by the system. Further, the processor is configured to determine the one or more users for targeted advertisement based on the keywords input by the advertisement campaign manager and the selected additional keywords.

The system also includes a display for presenting a list of one or more users to the advertisement campaign manager. The list of the one or more users is divided into one or more sub-groups, for example, a group of influencers, a group of affected users, and a group of potentials.

According to yet another embodiment of the present invention, a computer program product to be used with a computer is provided. The computer program product includes a tangible computer usable medium having a computer readable program code embodied therein to provide targeted advertisements to the user. The computer program code includes program instructions for determining a set of signals corresponding to at least one online activity associated with the user. The set of signals include at least one of a share signal, a view signal, a search signal, and a click signal.

The computer program code includes program instructions for analyzing the set of signals to identify the one or more user interests. Further, the computer program code includes program instructions for tagging the user with at least one ad exchange cookie based on the one or more user interests and an available advertisement pool. The computer program code also includes program instructions to display, by an advertisement network, an advertisement to the user based on the ad exchange cookie.

According to yet another embodiment of the present invention, a computer program product for use with a computer is provided. The computer program product includes a tangible computer usable medium having a computer readable program code embodied therein for analyzing a set of signals to identify the one or more user interests corresponding to the user. The computer program code includes program instructions for identifying at least one of the following tasks, based on information present in the set of signals, performed by the user: accessing a webpage, searching a query, clicking on a Uniform Resource Locator (URL), and sharing data. Further, the computer program code includes program instructions for determining at least one of the following: one or more keywords present in at least one of the webpage accessed by the user, the search query input by the user, the click performed by the user, and the data shared by the user.

The computer program code includes program instructions for using an online information source to analyze the one or more keywords to determine the one or more user interests.

According to yet another embodiment of the present invention, a computer program product for use with a computer is provided. The computer program product includes a tangible computer usable medium having a computer readable program code embodied therein to identify one or more users from a plurality of users for a predefined targeted advertisement. The computer program code includes program instructions for analyzing a set of signals associated with a user of the plurality of users. The set of signals includes at least one of a share signal, a view signal, a search signal, and a click signal.

The computer program code includes program instructions for identifying the one or more user interests for a user of the plurality of users based on the analysis of the set of signals. Further,.the computer program code includes program instructions for matching the identified one or more user interests for the user with the predefined targeted advertisement. In addition, it includes program instructions for determining the one or more users from the plurality of users for the predefined targeted advertisement based on the matching.

According to yet another embodiment of the present invention, a computer program product for use with a computer is provided. The computer program product includes a tangible computer usable medium having a computer readable program code embodied therein to allow an advertisement campaign manager to identify the one or more users for targeted advertisements. The computer program code includes program instructions for providing an online tool to the advertisement campaign manager to allow him/her to input keywords associated with the targeted advertisements. Further, the computer program code includes program instructions for using a predefined page level co-occurrence algorithm to determine one or more additional keywords related to the keywords input by the advertisement campaign manager.

The computer program code includes program instructions for providing an option to the advertisement campaign manager to select additional keywords from the determined one or more additional keywords. Additionally, the computer program code includes program instructions to determine the one or more users for targeted advertisement based on the keywords input by the advertisement campaign manager and the selected additional keywords. It also includes program instructions for presenting a list of the one or more users to the advertisement campaign manager. In accordance with an embodiment of the present invention, the list of one or more users is divided into one or more sub-groups, for example, a group of influencers, a group of affected users, and a group of potentials.

An objective of the present invention is to provide a method, system and a computer program product for targeted advertisement, in which not only the website being viewed by the user is considered for targeted advertisement, but also the user's other “online activities” are tracked to display targeted advertisement to him/her. The user's online activities include, for instance, the search query input by him/her on a search engine or a webpage that is “shared” with other users.

Another objective of the present invention is to provide a method, system and a computer program product for identifying the user's interests by analyzing the user's various online activities and by using an online information source, such as Wikipedia®.

Yet another objective of the present invention is to provide a method, system and a computer program product which permits an advertisement campaign manager to identify users from the plurality of users for targeted advertisement and also to view his/her campaign's success or report through an online tool.

### BRIEF DESCRIPTION OF THE DRAWINGS

The preferred embodiments of the invention will, hereinafter, be described in conjunction with the appended drawings provided to illustrate, but not to limit, the invention, wherein like designations denote like elements, and in which:

FIG. 1 is a flowchart for providing targeted advertisements to a user, in accordance with an embodiment of the present invention;

FIG. 2 is a flowchart for analyzing a set of signals to identify one or more user interests corresponding to a user, in accordance with an embodiment of the present invention;

FIG. 3 is a flowchart for identifying one or more users from a plurality of users for a predefined targeted advertisement, in accordance with an embodiment of the present invention;

FIGS. 4-9 are exemplary charts for information used and analyzed for selecting users for the targeted advertisement, in accordance with an embodiment of the present invention;

FIG. 10 is a flowchart for allowing an advertisement campaign manager to identify the one or more users for targeted advertisements using an online tool, in accordance with an embodiment of the present invention;

FIGS. 11-15 are exemplary snapshots of an online tool that can be used by an advertisement campaign manager, in accordance with an embodiment of the present invention;.

FIGS. 16 and 17 are exemplary snapshots of the online tool which allow the advertisement campaign manager to view his advertisement campaign's progress or effectiveness; and

FIG. 18 is a block diagram of a system for providing targeted advertisements to a user, in accordance with an embodiment of the present invention.

### DETAILED DESCRIPTION OF THE INVENTION

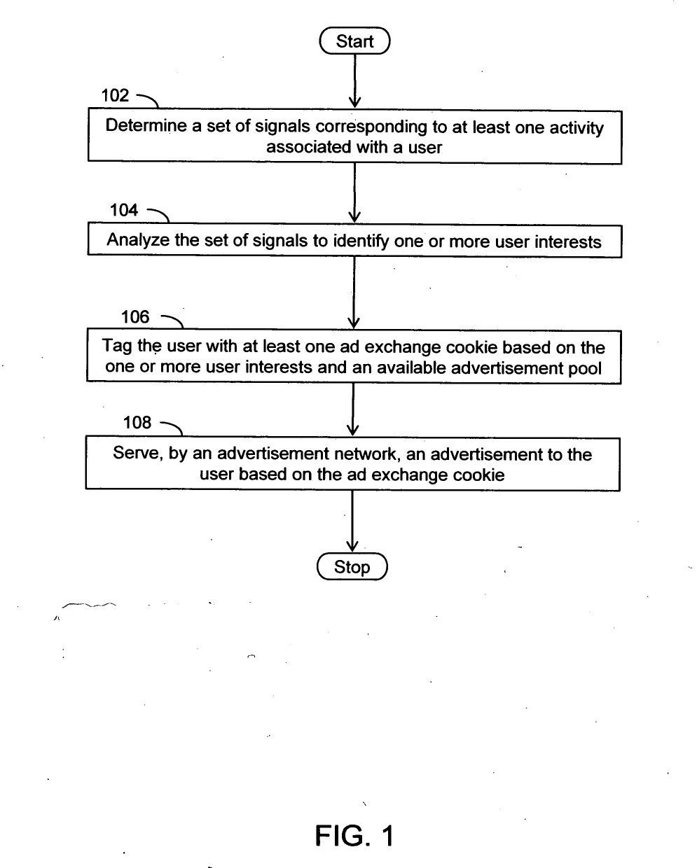

FIG. 1 is a flowchart for providing targeted advertisements to a user, in accordance with an embodiment of the present invention. At step 102, a set of signals is determined corresponding to the user's at least one online activity. The online activity can be, for example, clicking on a link, viewing a particular website, inputting a search query, or sharing a webpage with other users through email or social networking websites, etc.

In accordance with an embodiment of the present invention, the set of signals includes a “share signal” corresponding to the data shared by the user with other users, a “view signal” corresponding to the webpage browsed by the user, a “search signal” corresponding to a search query executed by the user and a “click signal” corresponding to a Web link clicked by the user.

The term “signal” used in this patent application means “information” that can be obtained from the user's online activities. For example, a share signal denotes the information that can be extracted from the data that is shared by the user with other users. As already mentioned, a set of signals is determined for a user at step 102. Essentially, at this step, “information” regarding the following user actions is gathered: the websites browsed, links clicked, search queries entered, and data shared with other users.

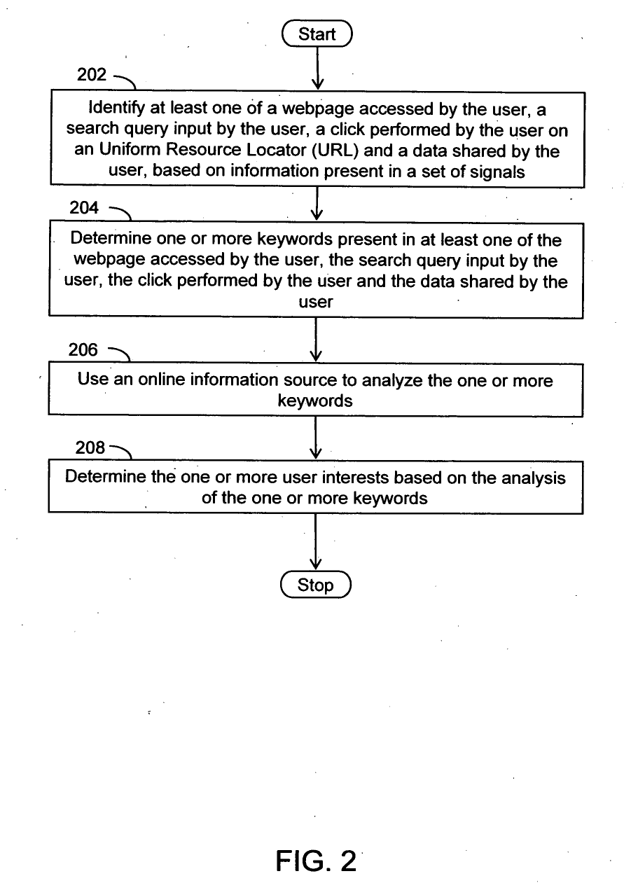

At step 104, the set of signals is analyzed to identify one or more user interests. In accordance with an embodiment of the present invention, analyzing the set of signals includes determining the keywords present in the signals to identify user interests. An online information source, such as Wikipedia®, can be used to identify the user interests using the determined keywords. Step 104 is described in detail in FIG. 2.

At step 106, the user is tagged with at least one ad exchange cookie based on the identified user interests and an available advertisement pool. For example, if it is identified at step 104 that the user interests involve sports, an ad exchange cookie corresponding to a “sports shoe” advertisement may be tagged to the user, if the sport shoe advertisement is present in an available advertisement pool. Typically, the advertisement pool is maintained and stored by an advertisement network or a service provider that provides the service to multiple campaign managers to identify users for targeted advertisement.

At step 108, an advertisement is displayed to the user by the advertisement network based on the ad exchange cookie. Continuing with the above example, if the user is tagged with the sports shoe ad exchange cookie, the corresponding sports shoe advertisement is displayed to the user. In accordance with an embodiment of the present invention, the advertisement is displayed on the webpage being browsed by the user.

FIG. 2 is a flowchart for analyzing a set of signals to identify the one or more user interests corresponding to the user, in accordance with an embodiment of the present invention.

As already mentioned in FIG. 1, the set of signals corresponds to a view signal, a share signal, a click signal, and a search signal associated with the user's at least one online activity. This set of signals is determined for the user, and the signals are analyzed to determine user interests. The description of FIG. 2 is related to the process of determining user interests from the determined set of signals.

At step 202, at least one of a webpage accessed by the user, a search query input by the user, a click performed by the user on a Uniform Resource Locator (URL) and a data shared by the user is identified based on the information present in the set of signals. Generally, the information present in the signal would itself be the URL clicked by the user, the search query input by the user, the webpage accessed by the user or the data shared by the user.

At step 204, one or more keywords present in the webpage accessed by the user, the search query input by the user, the click performed by the user (URL) and the data shared by the user are determined. For example, keywords such as phone, subscriber identity module (SIM), wireless, mobile, etc., may be determined from a webpage accessed by the user (if the webpage is about mobile phones) or shared with other users.

At step 206, an online information source, such as Wikipedia®, is used to analyze the determined keywords. For instance, if the keywords determined from the set of signals are phone, SIM, mobile, etc., Wikipedia® is used to establish that the webpage from which the keywords are taken must be related to mobile phones or “technology” in general. Essentially, Wikipedia® is used to determine the “category” to which the webpage belongs (for example, the category in the example mentioned above is “technology”).

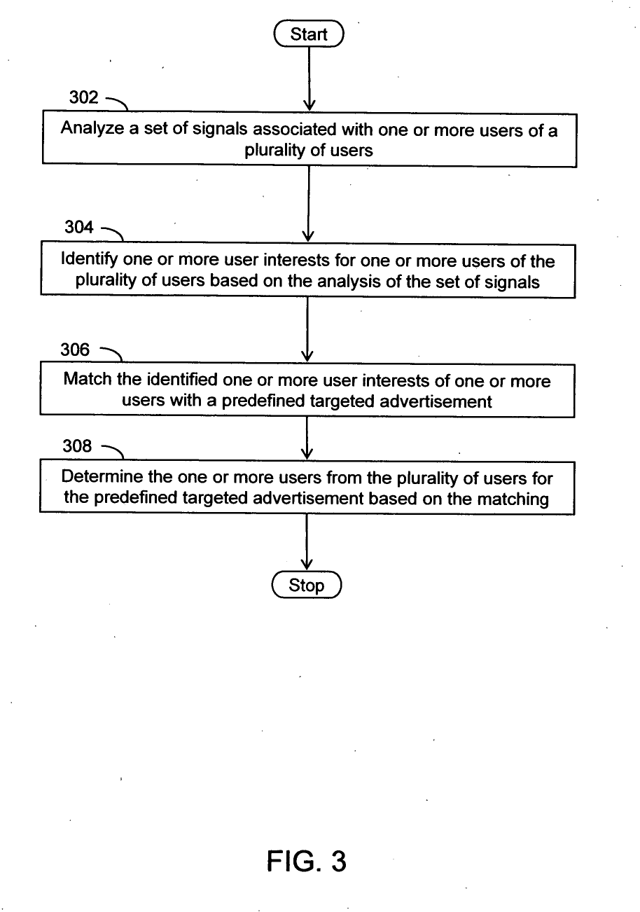

At step 208, the one or more user interests are determined based on the analysis of the keywords identified from the set of signals. For example, if it is determined that out of 10 webpages accessed by the user, 8 belong to the “technology” category, one belongs to the “entertainment” category, and one belongs to the “fashion” category, it is assumed that the user's interests lie in technology. The detailed process of identifying user interests from “categories” is described in FIG. 3.

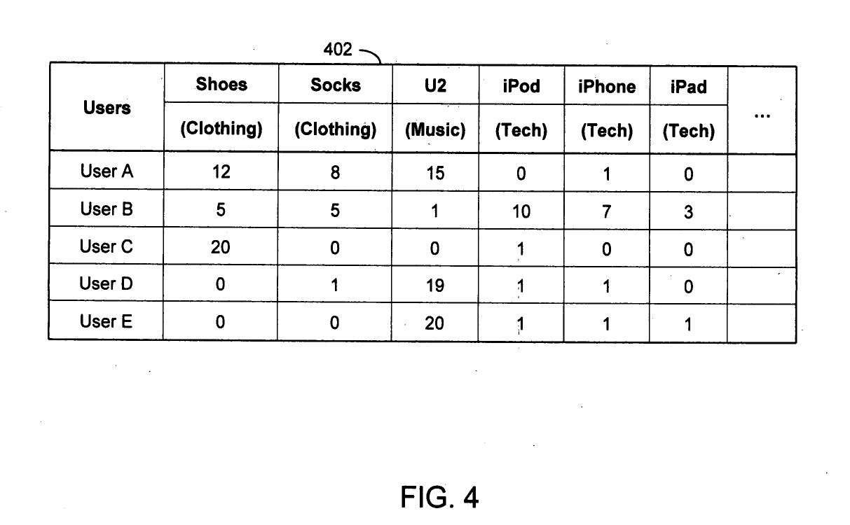

FIG. 3 is a flowchart for identifying one or more users from a plurality of users for a predefined targeted advertisement, in accordance with an embodiment of the present invention. While describing FIG. 3, references will be made to FIGS. 4-9, which are exemplary charts for information used for selecting users for the targeted advertisement.

At step 302, a set of signals associated with one or more users of a plurality of users is analyzed. Typically, a pool of users (for example a predefined number of users from a geographical area) is considered for analysis and a set of signals associated with one or more users is analyzed separately. For instance, for each user, it is determined which webpages have been browsed by the user in the past 30 days, what webpages are shared by the user in the past 30 days, what Web links are clicked by the user in the past 30 days, etc. Those ordinarily skilled in the art will appreciate that the time duration of 30 days is used just as an example and any other time duration can be considered without departing from the scope of the invention.

As already explained in FIG. 2, signals are analyzed to extract keywords from the signals and Wikipedia® is used to identify categories to which the user belongs.

The output of step 302 is a chart 402 as shown in FIG. 4. As shown in an exemplary chart 402, a user “User A” has browsed, clicked, shared, or searched 12 webpages which had keyword “shoes” in them. Similarly, “User A” browsed, clicked, shared, or searched 8 webpages which had a keyword “socks” in them. On similar lines, details are gathered for other users and other keywords, as shown in chart 402. In addition, shown in chart 402 are the categories to which these keywords belong, for example, “shoes” belong to “clothing”, “U2” belongs to “music”, “iPod” belongs to “technology”, etc.

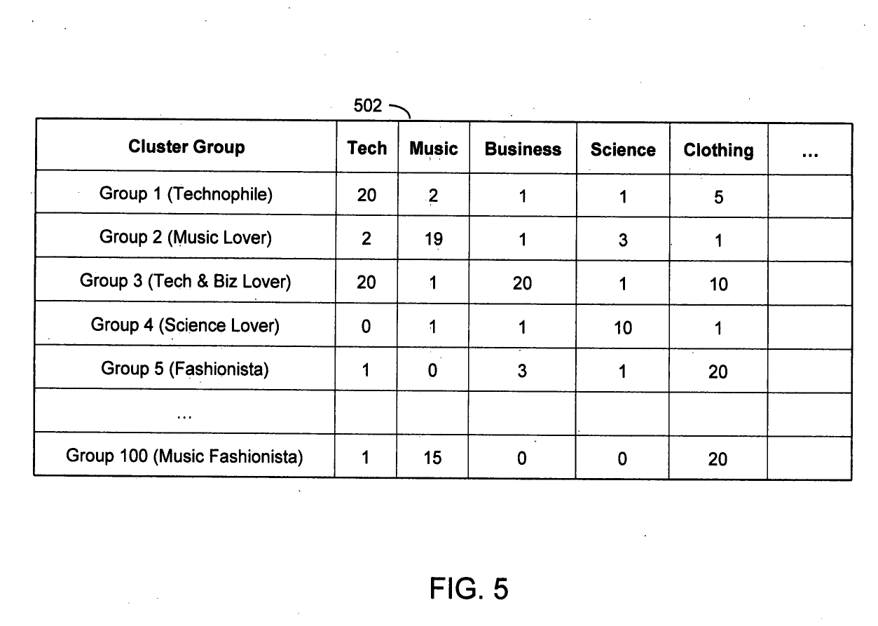

Once chart 402 is prepared, at step 304, one or more user interests for one or more users are identified based on the analysis of the set of signals. Step 304 is explained using chart 502 shown in FIG. 5.

As shown in chart 502, first groups are made based on data gathered for the plurality of users. For example, group 1 is for technophiles (persons whose interest is in technology), group 2 is for music lovers, and so on. The data shown in the rows for each group depicts data for a particular user. For example, in chart 502, the first user (not shown) belongs to the technophile group (which is shown as Group 1 in chart 502), the second user belongs to the music lover group, the third user belongs to both technophile and business lover groups, and so on. Based on the number of “hits” for each category (for example Tech, Music, Business, etc.), a user is categorized into groups, as shown in chart 502. For example, the first user shown in chart 502 has 20 hits on technology websites or webpages, 2 hits on music websites or webpages, and so on. The term “hits” for a category here refers to the number of URLs clicked by the user, webpages shared by the user with other users, webpages browsed by the user, and search queries inputted by the user having the keyword(s) for the corresponding category.

Although chart 502 shows 100 groups, it will be apparent to a person ordinarily skilled in the art that more or less number of groups can be made based on user data.

Once chart 502 is formed, at step 306, the identified user interests of one or more users are matched to a predefined advertisement campaign. For example, if an advertisement campaign manager is planning to run an advertisement campaign and wants to know which users to target, the data identified up to step 304 will be utilized by the manager to match user interests with the advertisement campaign. For instance, if the advertisement campaign is about “clothing”, the users which have clothing as one of their interests are identified as “potential” targets for advertisements. Specifically, if the advertisement campaign manager is targeting users interested in “shoes”, he/she will have those people as “potential” targets who have clicked on URLs, accessed or shared webpages containing, for example, “shoes” or “socks” as keywords.

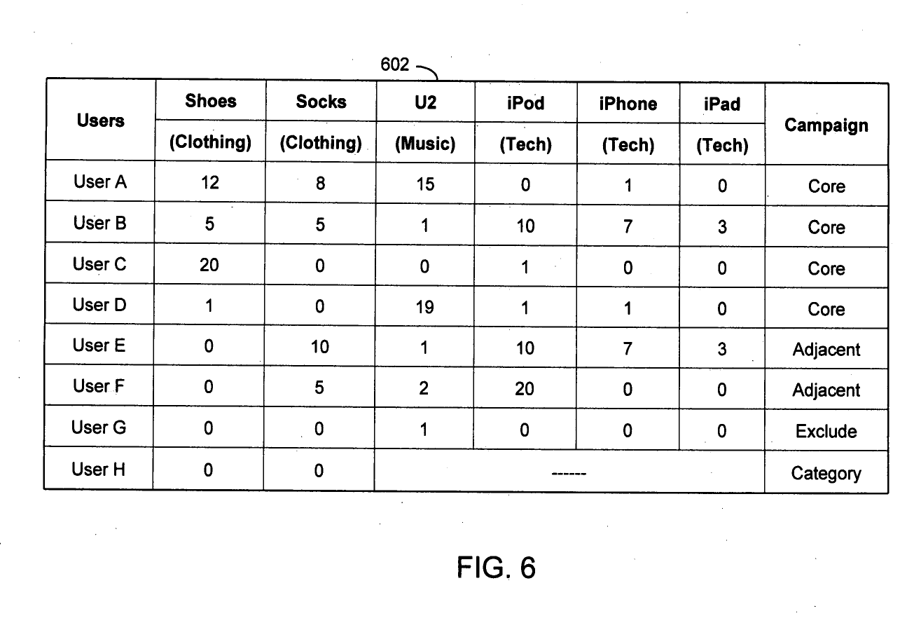

An example is shown in chart 602 of FIG. 6. As shown in the chart, it is assumed that the users having at least one hit for keyword “shoes” form a “core” campaign group. For instance, the core campaign group can be the group of users who are “higher up” in the list of potential targets for the advertisement campaign. Further, those users who have hits corresponding to keyword “socks” but no hit corresponding to keyword “shoes” form an “adjacent” campaign group. The users in an adjacent campaign group are those users who are potential targets but figure “lower down” in the list of prospective targets.

Those ordinarily skilled in the art will appreciate that the terms mentioned above, such as “core” and “adjacent”, are exemplary in nature and do not limit the scope of the invention in any way. More campaign groups can be added based on the preferences of the advertisement campaign manager, without departing from the scope of the present invention.

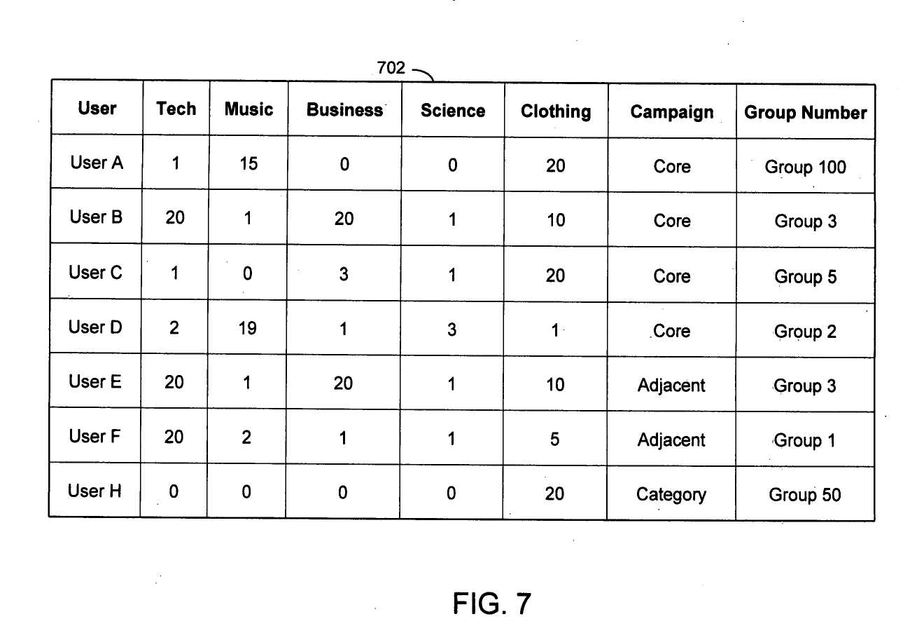

Once users belonging to “core” and “adjacent” campaign groups are identified, a chart 702 (as shown in FIG. 7) is prepared which combines the data of chart 502 and chart 602. The “group number” mentioned in chart 702 is just an identification for a particular group of users. For example, user A is shown to belong to group number 100, which can be a group of users having interests in music and fashion. Similarly, group 2 may include users having interests in music, and so on. Also, for each user, the campaign group for each user is mentioned. For example, user A is shown to belong to a core group, user E is shown to belong to an adjacent group, and so on.

Once chart 702 is prepared, at step 308, the one or more users are determined from the plurality of users for the targeted advertisement campaign. In accordance with an embodiment of the present invention, to determine users for the targeted advertisement from the plurality of users, one or more calculations are performed based on the information present in chart 702. In addition, decisions about which user to select for the targeted advertisement are made. Some illustrative formulas used for the calculations and the process followed to select users for targeted advertisement are described below.

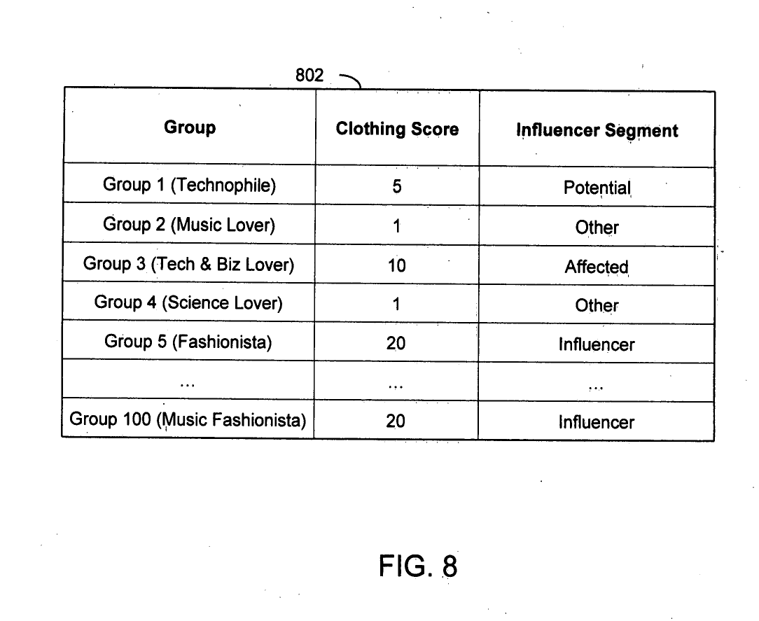

To explain the process, it is assumed that the targeted advertisement is related to clothing. As shown in chart 802 of FIG. 8, users are first segregated into groups and their “clothing” hits are tabulated. For example, the first user (belonging to “Technophile” group) is shown to have 5 clothing hits, second user has 1 clothing hit, and so on. Thereafter, the following formulas are used to determine whether the user is a “potential”, “affected”, “influencer” or “other”. These categories can be defined with the help of the following formulas:

A user is said to be an “influencer” if the “category score”>mean (μ)+2*standard deviation (σ). For example, the category score for the first user would be 5.

A user is said to be “affected” if μ+a<category score<p+2σ.

A user is said to be “potential” if μ−0.5*a<category score<μ+σ.

A user is said to be belonging to “others” category if category score<μ−0.5*σ.

Typically, if a user has a high category score, he/she is assumed to be an “influencer”. In other words, the user is assumed to be so much involved into clothing and fashion that he can “influence” other users as well. It is assumed that the user who is an influencer would be best fit for the targeted advertisement. Second, the user is said to be “affected”, if he/she has lower number of hits for clothing than the “influencers”, but still has reasonably high number of hits. For example, in chart 802, group 3 has 10 hits, which is lower than the hits for group 5 (20), but still higher than other groups.

A user is said to be a “potential” if he/she has at least some (for example more than 1 or 2 hits) hits. These hits are much lower than the hits of influencers and affected. For example, in chart 802, group 1 is a potential, as it has just 5 hits, which is lower than the hits of influencers and affected.

“Others” are those users who have a considerably lower number of hits than any of the three categories mentioned above. Moreover, these are those users who are not considered for the targeted advertisement.

Those ordinarily skilled in the art will appreciate that the formula mentioned above is exemplary in nature and any other formula can be used to categorize users without departing from the scope of the invention. Also, although it is mentioned that the users are classified based on the number of hits (corresponding to view signal, share signal, click signal and search signal), there can be another embodiments of the present invention where a single user can be classified into different categories based on his/her number of hits corresponding to share, click, search and view signals separately. For example, a user can be an ‘influencer’ based on his share signal, but can be a ‘listener’ based on his click signal.

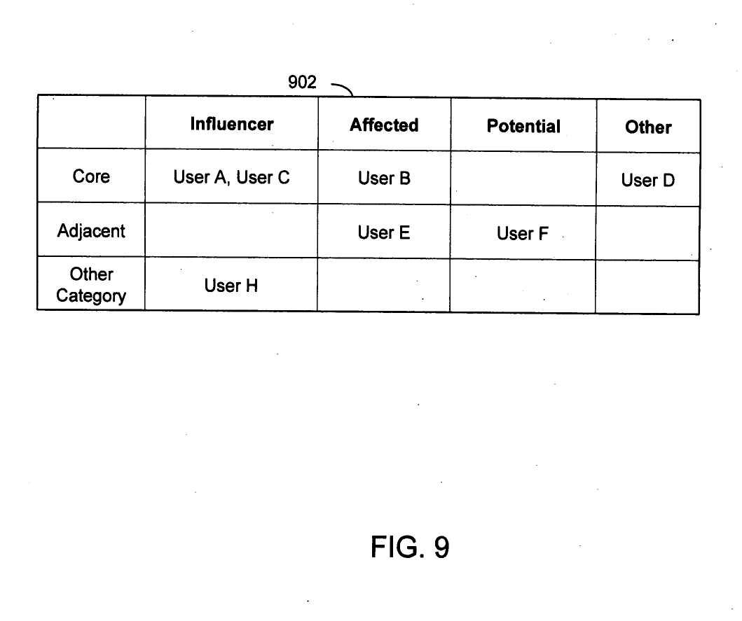

FIG. 9 shows an embodiment of a chart 902 which can be prepared after the users belonging to influencers, affected, potential, and others groups are identified. As shown in chart 902, users are categorized into two categories, i.e., core/adjacent or any other category and influencer/affected/potential/others.

Chart 902 is used by a campaign manager to determine which users to target. For example, if the manager wants to target only a few users, he/she will choose users belonging to core and influencers. Further, he/she may also want to provide different advertisements to different sets of users. For example, the manager can provide different ads to users belonging to core and influencers and different ads to users belonging to core and affected. The ads for core and influencers can be, for example, more detailed and can have custom offers in it, than the ads for users belonging to core and affected.

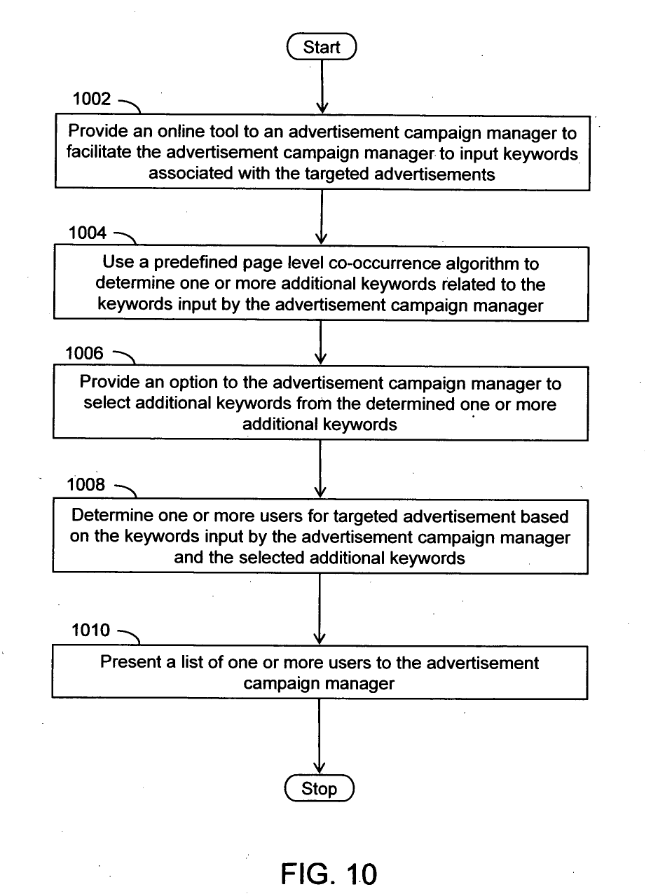

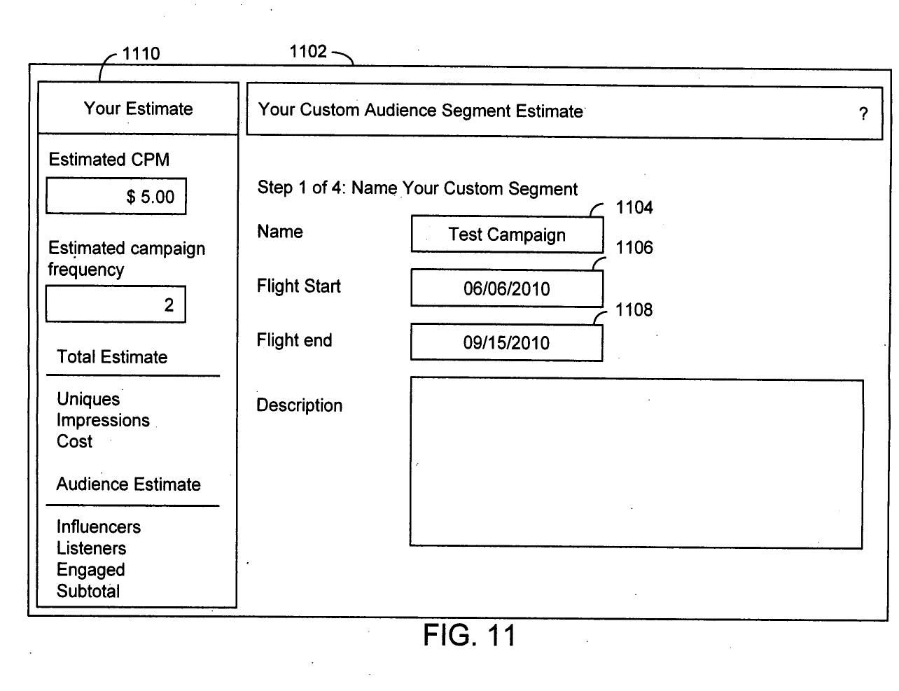

FIG. 10 is a flowchart for allowing an advertisement campaign manager to identify the one or more users for targeted advertisements using an online tool, in accordance with an embodiment of the present invention. While describing FIG. 10, references will be made to FIGS. 11-14, which are exemplary snapshots of the online tool that is used by an advertisement campaign manager.

At step 1002, an online tool is provided to an advertisement campaign manager to allow him/her to input keywords or topics associated with the targeted advertisements. A snapshot of an exemplary online tool 1102 is shown in FIG. 11. Online tool 1102 includes tabs for inputting campaign's name 1104, start time 1106, and end time 1108. The manager can even provide a description of his/her campaign in the “description” tab shown on online tool 1102.

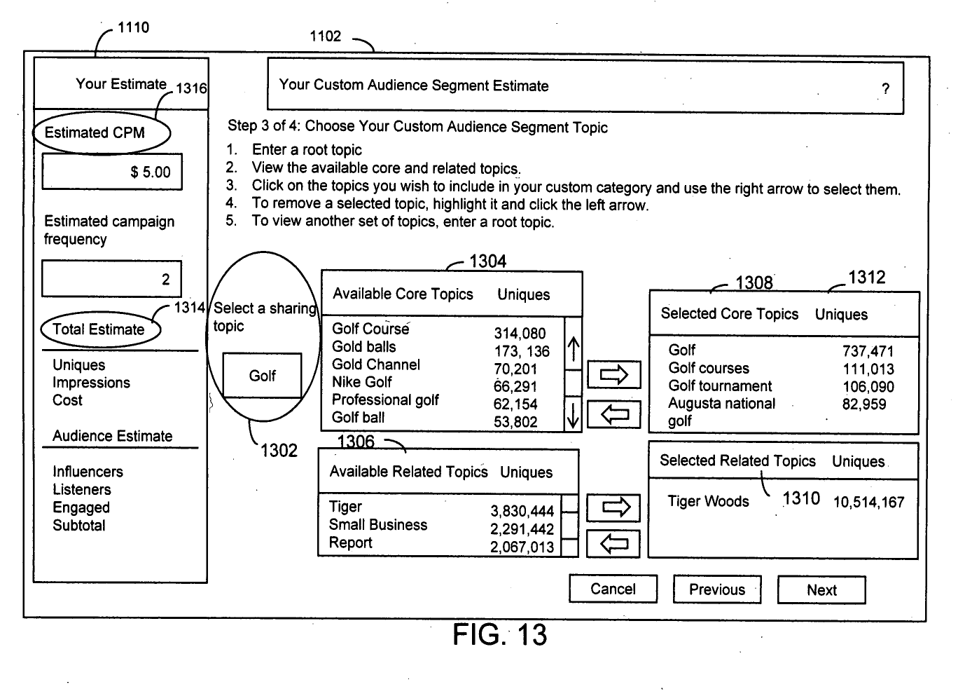

The description of tabs shown under “Your Estimate” 1110 will be explained in the description of FIG. 13.

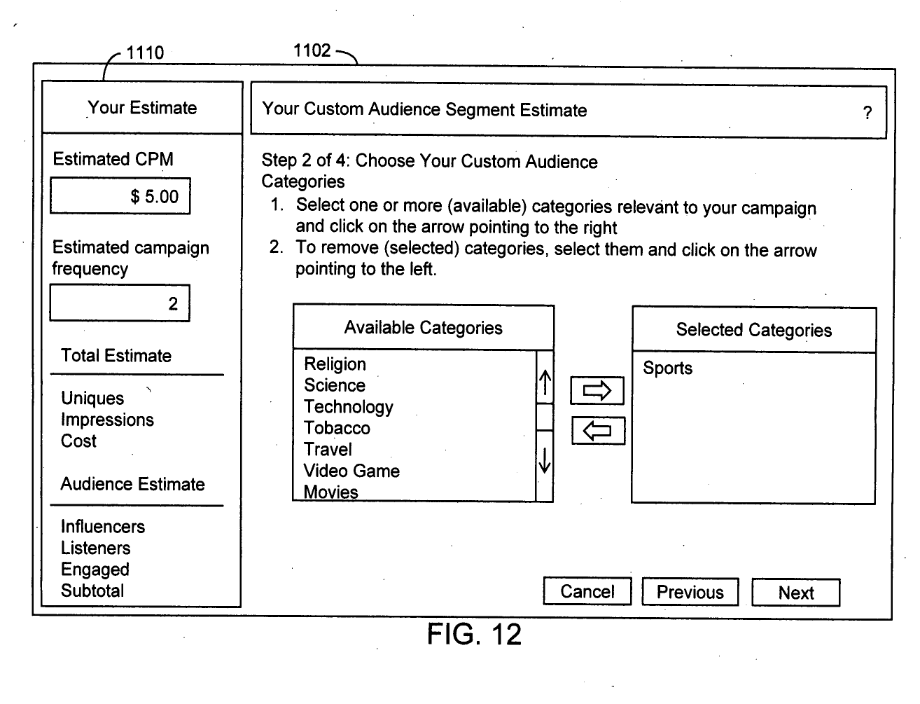

FIG. 12 shows another snapshot of online tool 1102 where the campaign manager can select the ‘category’ to which his/her advertisement campaign belongs. For example, in FIG. 12, it is shown that the manager selects “sports” as the category to which his/her campaign belongs. In accordance with an embodiment of the present invention, the manager can even select more than one category.

FIG. 13 shows yet another snapshot of online tool 1102, which shows a tab 1302 where the manager can input the topic that is closely related to his/her advertisement campaign. The snapshot shows the manager adding the topic “golf” in tab 1302.

Once the manager adds the topic related to the advertisement campaign, two recommendation lists are provided to the manager. These are: “Core Topics” 1304 and “Related Topics” 1306. The “core topics” are those which directly contain the topic selected by the manager. For example, if the manager selects the topic ‘golf’, all the other topics which contain the keyword ‘golf’ are shown to the manager under ‘Core Topics’ 1304. This is shown in FIG. 13. Further, “related topics” are those which are identified by a predefined page level co-occurrence algorithm. This is shown as step 1004 in FIG. 10. In accordance with an embodiment of the present invention, at step 1004, additional topics that are related to the selected topic (golf) are identified by doing a statistical co-occurrence analysis, i.e., topics that are most likely to be seen on the same pages where “golf” is seen are identified and provided to the manager under ‘related topics’. For example, “tiger woods” is one topic found to be “related” to topic “golf”.

The manager can further select/deselect the topics between the recommendation lists and the selected topic lists by using the arrow buttons provided. Noticeably, the topics can be moved between “Available Core Topics” 1304 and “Selected Core Topics” 1308, and between “Available Related Topics” 1306 and “Selected Related Topics” 1310.

Once the topics are populated into selected lists 1308 and 1310, the corresponding unique user numbers are provided for each of them for information purpose. For example, as shown in FIG. 13, for selected core topic “golf”, there are “737,471” unique users identified with this topic interest, and the numbers for “golf courses” and “golf tournament” are “111,013” and “106,090” respectively. This is shown under the tab “Uniques” 1312.

In accordance with an embodiment of the present invention, the topics in 1308 and 1310 together define an “Audience Segmentation”, i.e., the audience or the users identified having interests overlapping with 1308 and 1310. The total size of the audience segmentation is provided under the tab ‘Total Estimate’ 1314. As shown, the total unique user number in the audience segmentation is “11,551,700”. Those ordinarily skilled in the art will appreciate that this number is not the sum of the numbers in 1308 and 1310 because there are overlapping users who belong to multiple topics. Therefore the total unique number is always smaller than the sum of topic level unique estimation.

In addition to ‘Uniques’, FIG. 13 also shows tabs for “Impressions” and ‘costs’. Those ordinarily skilled in the art will appreciate that cost is determined based on CPM, which is ‘cost per mille’ or ‘cost per thousand page impressions’. The manager can input an “Estimated CPM” (which is shown as tab 1316 in FIG. 13), which together with the ‘impressions’ provide cost estimation. In the example shown in FIG. 13, estimated CPM input by the manager is “$5” and the cost estimation to run the campaign is “$115,517.00”.

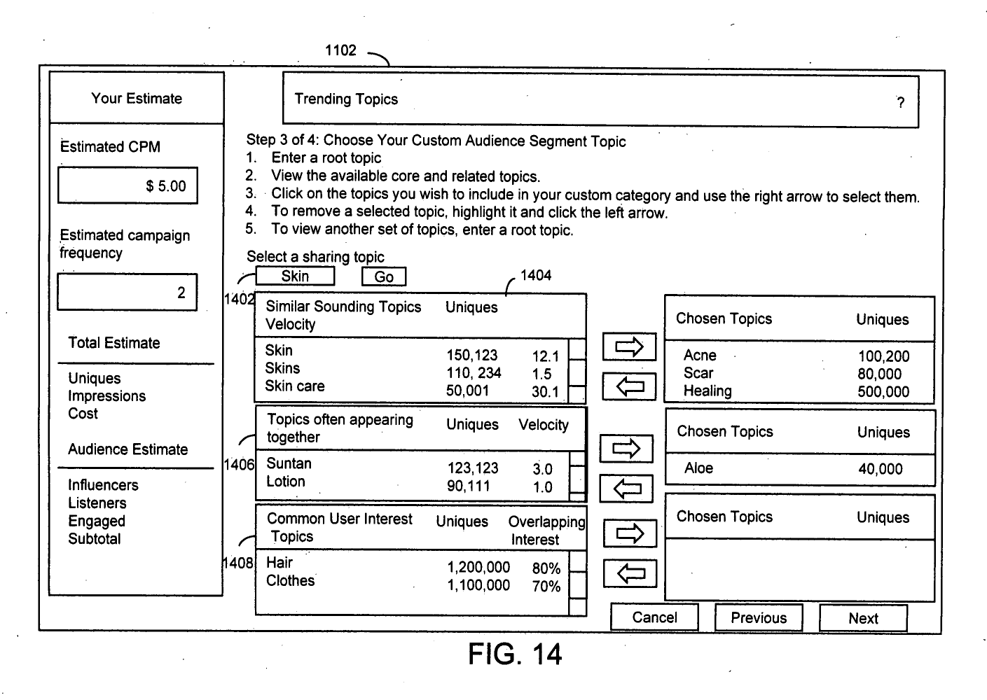

Another embodiment of the snapshot shown in FIG. 13 is depicted in FIG. 14. As shown in FIG. 14, the manager inputs the root topic as “skin” in tab 1402. A list of “similar sounding topics” 1404, “topics often appearing together” 1406, and “common user interest topics” 1408 containing topics or keywords related to “skin” is shown to the manager. The term “velocity” depicted in FIG. 14 means aggregate clicks for that topic over a period of time. For example, for the topic “skin”, there have been 12.1 clicks over a period of time, for example, 30 days. Further, “overlapping interest” denotes the percentage closeness of the topics with the root topic. For example, the topic “hair” is depicted to have 80% closeness with “skin”. In accordance with an embodiment of the present invention, overlapping interest can be determined based on the percentage of total pages having both keywords skin and hair on them. For example, if 80% of all the pages having keyword “skin” also have keyword ‘hair’ in them, the overlap interest is 80%.

At step 1006, an option is provided to the manager to select keywords from the list of additional keywords or topics shown to him/her. As shown in FIG. 13, the manager can select topics from the core topic list 1304 and the related topic list 1306 shown to him/her. For instance, the manager is shown to select golf, golf courses, golf tournament, augusta national golf, and Tiger Woods, as the topics related to his/her advertisement campaign. Similar option is depicted in FIG. 14, where the manager selects the topics “acne”, “scar”, “healing”, “stretch marks”, “aloe”, and “tanning”.

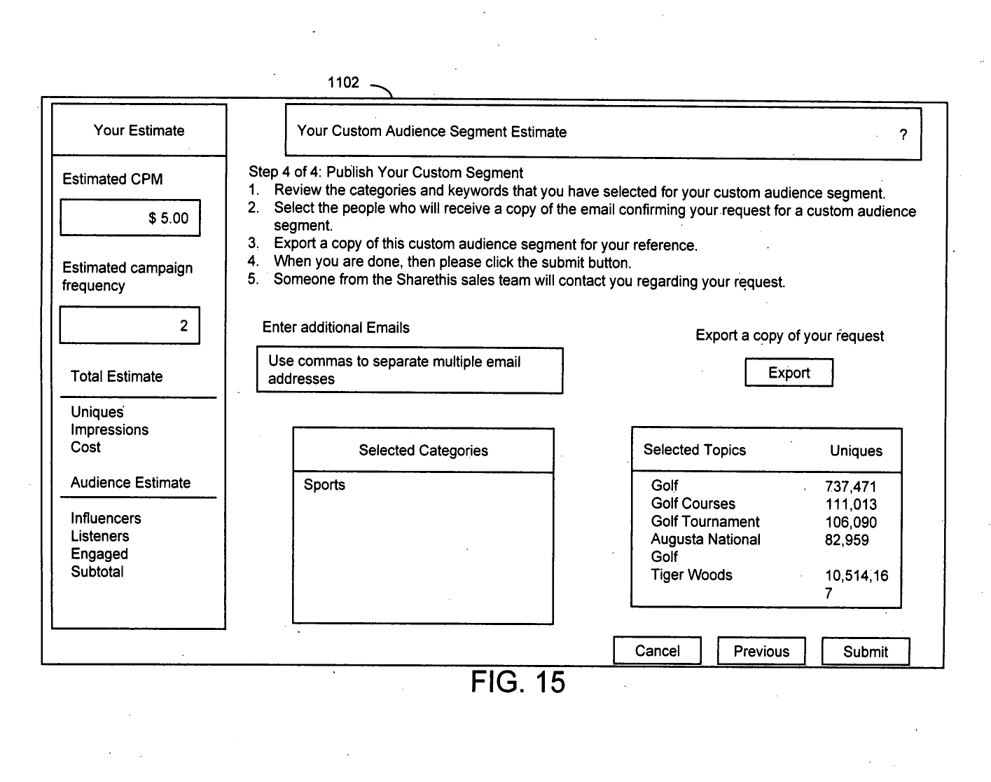

Once the manager selects the topics, he/she is shown a page on online tool 1102 which asks the manager to confirm his selection. A snapshot of such a page is shown in FIG. 15. As shown in the figure, the manager is shown the selections he/she has made and the tool asks him/her to confirm before submitting. The manager is also given an option to export (for example in MS® Excel® or MS® Word® format) his selections and to provide email addresses of contacts associated with the advertisement campaign to whom the list of selections can be sent. Once the manager has checked his selections and added the required details, he/she can submit his selections.

Once the user has submitted the selections, at step 1008, the one or more users are determined for targeted advertisement based on the manager's selections. The entire process of identifying users for targeted advertisement has already been explained in regard to FIG. 3.

Thereafter, at step 1010, the list of one or more users identified for targeted advertisement is presented to the campaign manager via online tool 1102 or sent via email.

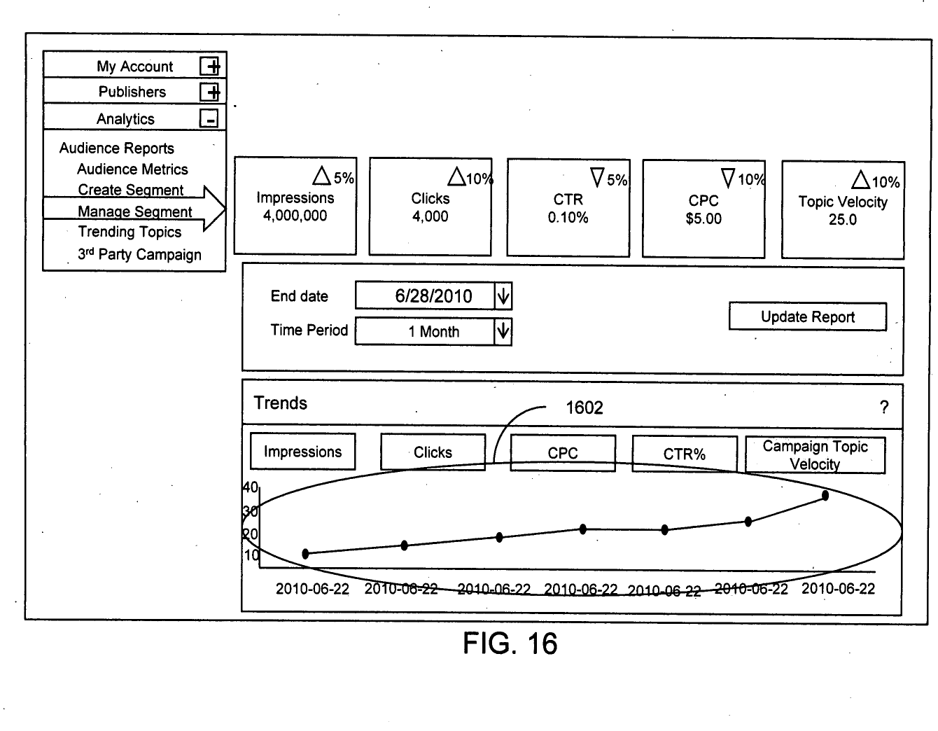

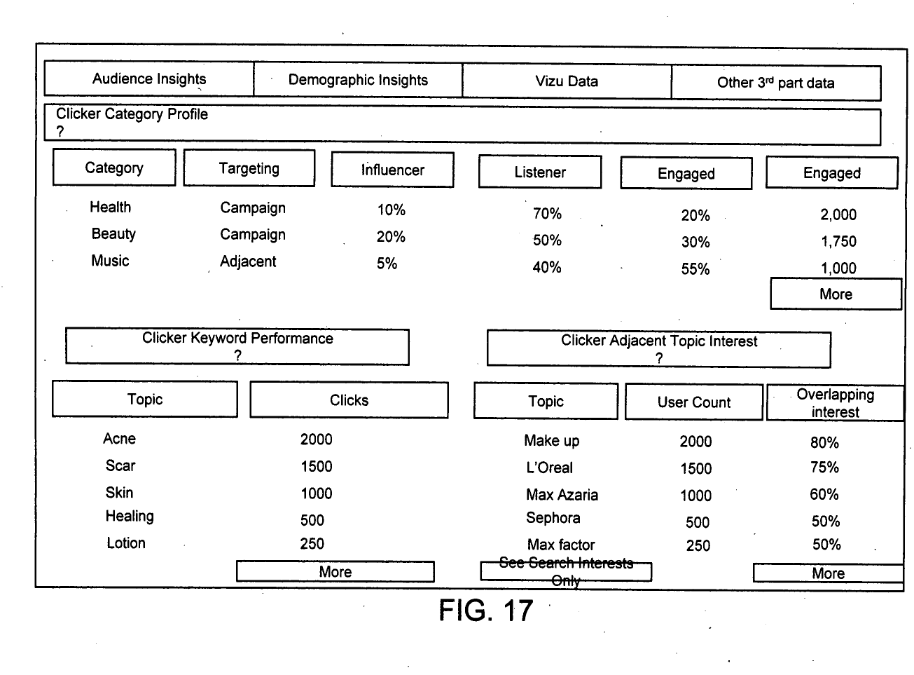

FIGS. 16 and 17 are exemplary snapshots of online tool 1102 which allow the advertisement campaign manager to view his advertisement campaign's progress or effectiveness. In the snapshot shown in FIG. 16, the manager can view how the campaign topic velocity for his/her campaign has increased or decreased over a period of time. For example, the trend 1602 shown in FIG. 16 depicts that the topic velocity of the particular campaign has increased from Jun. 22, 2010 to Jun. 28, 2010. Topic velocity, basically, is the aggregate number of ‘clicks’ and ‘data shares’ done by the users for the particular campaign. For example, the campaign is ‘golf’ and the manager selects the keywords ‘golf’ and ‘Tiger Woods’, topic velocity depicts how many ‘clicks’ and ‘shares’ have occurred for web pages containing these keywords or keywords related to these topics.

Similarly, FIG. 17 shows the manager the total number of clicks that have been performed for his campaign and the profile of clickers, which helps the manager in better understanding clickers' interests. For example, as shown in FIG. 17, at the category level, the clickers belong to three top categories: “health”, “beauty”, and “music”. Out of these three categories, the first two are already included in the campaign, while the third one is an adjacent category. For each category, the distribution of clickers in “Influencer”, “Listener”, and “Engaged” groups is also shown to the manager through online tool 1102. In accordance with an embodiment of the present invention, the group ‘listener’ is the same as the group ‘affected’ and the group ‘engaged’ is the same as ‘potential’, as described in previous figures. The terms can be used interchangeably without altering the scope of the present invention.

In addition to category level profiles, the clickers are also grouped by their topic interests. For example, clickers with topic interest in “Acne” have contributed 2000 clicks, clickers with topic interest in “Scar” have made 1500 clicks and so on.

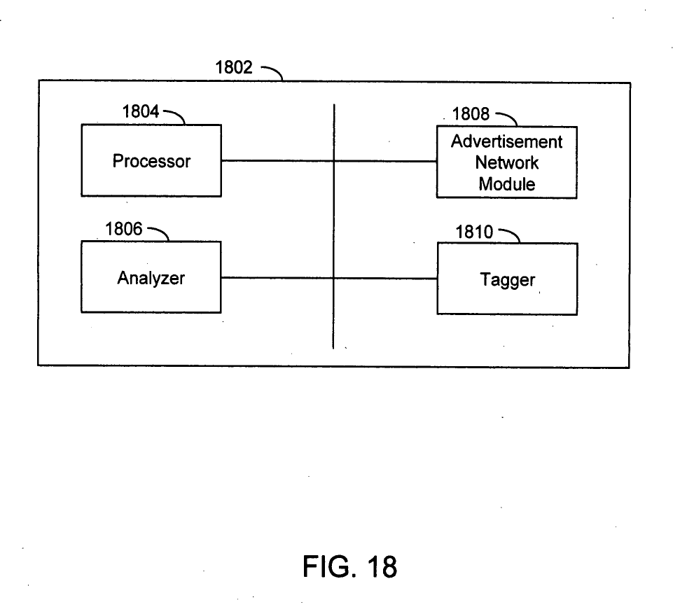

FIG. 18 is a block diagram of a system 1802 for providing targeted advertisements to the user, in accordance with an embodiment of the present invention. System 1802 includes a processor 1804, an analyzer 1806, an advertisement network module 1808, and a tagger 1810. System 1802 is a combination of hardware and software.

Processor 1804 is used to determine a set of signals corresponding to at least one online activity associated with the user. The online activity associated with the user can be, for example, clicking of a URL, browsing a webpage, inputting a search request, or sharing a webpage with other users. Once the set of signals is determined, analyzer 1806 analyzes it to identify the one or more user interests. Typically, analyzer 1806 uses an online information source, such as Wikipedia®, to analyze the set of signals and identify user interests. The entire process of identifying user interests is explained in FIG. 2 and FIG. 3.

After user interests are identified, tagger 1810 tags the user with at least one ad exchange cookie based on the identified user interests and an available advertisement pool. As already mentioned in FIG. 1, the available advertisement pool is maintained by an advertisement network.

Once the tagging is done, advertisement network module 1808 displays an advertisement to the user based on the ad exchange cookies.

In accordance with another embodiment of the present invention, processor 1804 is configured to perform three functions. The first function is to identify user interests for one or more users of the plurality of users based on the analysis of the set of signals by analyzer 1806. The second function is to match the identified user interests for the one or more users with a predefined targeted advertisement, and the third function is to determine one or more users from the plurality of users for the targeted advertisement based on the matching.

In accordance with yet another embodiment of the present invention, system 1802 also allows the campaign manager to plan his targeted advertisement campaign and identify the users for the targeted advertisements. Essentially, system 1802 presents the campaign manager with an online tool which he/she can view on the display of his personal or office computer, laptop, mobile phone, etc.

In this embodiment, the online tool allows the manager to input keywords associated with the targeted advertisement. Processor 1804 is configured to use a predefined page level co-occurrence algorithm to determine additional keywords related to the keywords inputted by the manager. These additional keywords are then displayed to the manager, and an option is provided to him/her to select some or all of the additional keywords.

Once the manager selects the additional keywords, processor 1804 determines a list of users for targeted advertisements based on the keywords inputted by the manager and the additionally selected keywords. Thereafter, the list of users is displayed to the manager.

Various embodiments of the present invention provide several advantages. First, using the present invention, a campaign manager planning an advertisement campaign can identify a set of users which he can target for his campaign. Second, the list of users to be targeted for the advertisement campaign is presented to the manager based on a combination of view signal, search signal, share signal, and click signal, which is not present in conventional methods and systems.

The method and system for providing targeted advertisements to a user, as described in the present invention, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system typically comprises a computer, an input device, and a display unit. The computer typically comprises a microprocessor, which is connected to a communication bus. The computer also includes a memory, which may include a Random Access Memory (RAM) and a Read Only Memory (ROM). Further, the computer system comprises a storage device, which can be a hard disk drive or a removable storage drive such as a floppy disk drive and an optical disk drive. The storage device can be other similar means for loading computer programs or other instructions into the computer system.

The computer system executes a set of instructions that are stored in one or more storage elements to process input data. These storage elements can also hold data or other information, as desired, and may be in the form of an information source or a physical memory element present in the processing machine. Exemplary storage elements include a hard disk, a DRAM, an SRAM, and an EPROM. The storage element may be external to the computer system and connected to or inserted into the computer, to be downloaded at or prior to the time of use. Examples of such external computer program products are computer-readable storage mediums such as CD-ROMS, Flash chips, and floppy disks.

The set of instructions may include various commands that instruct the processing machine to perform specific tasks such as the steps that constitute the method of the present invention. The set of instructions may be in the form of a software program. The software may be in various forms such as system software or application software. Further, the software may be in the form of a collection of separate programs, a program module with a large program, or a portion of a program module. The software may also include modular programming in the form of object-oriented programming. The software program that contains the set of instructions can be embedded in a computer program product for use with a computer, the computer program product comprising a tangible computer-usable medium with a computer-readable program code embodied therein. Processing of input data by the processing machine may be in response to users' commands, results of previous processing, or a request made by another processing machine.

The modules described herein may include processors and program instructions that are used to implement the functions of the modules described herein. Some or all the functions can be implemented by a state machine that has no stored program instructions, or in one or more Application-specific Integrated Circuits (ASICs), in which each function or some combinations of some of the functions are implemented as custom logic.

While the various embodiments of the invention have been illustrated and described, it will be clear that the invention is not limited only to these embodiments. Numerous modifications, changes, variations, substitutions, and equivalents will be apparent to those skilled in the art, without departing from the spirit and scope of the invention.

What is claimed is:

1. A method for providing targeted advertisements to a user, the method comprising:
determining a set of signals corresponding to at least one online activity associated with the user, wherein the set of signals comprises at least one of a share signal, a view signal, a search signal and a click signal;
analyzing the set of signals to identify one or more user interests;
tagging the user with at least one ad exchange cookie based on the one or more user interests and an available advertisement pool; and
serving, by an advertisement network, an advertisement to the user based on the ad exchange cookie.

2. The method of claim 1, wherein:
the view signal is associated with a web page browsed by the user;
the search signal is associated with a search query executed by the user;
the click signal is associated with a web link clicked by the user; and
the share signal is associated with a data shared by the user with one or more other users.

3. The method of claim 1, wherein analyzing the set of signals comprises determining one or more keywords present in the set of signals to identify the one or more user interests.

4. The method of claim 1, wherein the available advertisement pool is maintained by the advertisement network.

5. A method for analyzing a set of signals to identify one or more user interests corresponding to a user, the method comprising:
identifying at least one of a webpage accessed by the user, a search query input by the user, a click performed by the user on a Uniform Resource Locator (URL) and a data shared by the user, based on information present in the set of signals;
determining one or more keywords present in at least one of the webpage accessed by the user, the search query input by the user, the click performed by the user and the data shared by the user;
using an online information source to analyze the one or more keywords; and
determining the one or more user interests based on the analysis of the one or more keywords.

6. The method of claim 5, wherein the online information source is an encyclopedia website.

7. A method for identifying one or more users from a plurality of users for a predefined targeted advertisement, the method comprising:
analyzing a set of signals associated with one or more users of the plurality of users, wherein the set of signals comprises at least one of a share signal, a view signal, a search signal and a click signal;
identifying one or more user interests for the one or more users of the plurality of users based on the analysis of the set of signals;
matching the identified one or more user interests for the one or more users with the predefined targeted advertisement; and
determining the one or more users from the plurality of users for the predefined targeted advertisement based on the matching.

8. The method of claim 7, wherein:
the view signal is associated with a web page browsed by the user;
the search signal is associated with a search query executed by the user;
the click signal is associated with a web link clicked by the user; and
the share signal is associated with a data shared by the user with one or more other users.

9. The method of claim 7, wherein analyzing the set of signals associated with each user comprises identifying one or more keywords present in the set of signals to identify the one or more user interests of each user.

10. A method for permitting an advertisement campaign manager to identify one or more users for targeted advertisements, the method comprising:
providing an online tool to the advertisement campaign manager to allow the advertisement campaign manager to input keywords associated with the targeted advertisements;
using a predefined page level co-occurrence algorithm to determine one or more additional keywords related to the keywords input by the advertisement campaign manager;
providing an option to the advertisement campaign manager to select additional keywords from the determined one or more additional keywords;
determining one or more users for targeted advertisement based on the keywords input by the advertisement campaign manager and the selected additional keywords; and
presenting a list of one or more users to the advertisement campaign manager, wherein the list of one or more users is divided into one or more sub-groups.

11. The method of claim 10 further comprising using the online tool to determine an effectiveness of the targeted advertisement based on a number of clicks performed by the one or more users for the targeted advertisement.

12. The method of claim 10, wherein the one or more sub-groups comprises at least one of a group of influencers, a group of affected users and a group of potentials.

13. A system for providing targeted advertisements to a user, the system comprising:
a processor for determining a set of signals corresponding to at least one online activity associated with the user, wherein the set of signals comprises at least one of a share signal, a view signal, a search signal and a click signal;
an analyzer for analyzing the set of signals to identify one or more user interests;
a tagger for tagging the user with at least one ad exchange cookie based on the one or more user interests and an available advertisement pool; and
an advertisement network module for serving an advertisement to the user based on the ad exchange cookie.

14. The system of claim 13, wherein:
the view signal is associated with a web page browsed by the user;
the search signal is associated with a search query executed by the user;
the click signal is associated with a web link clicked by the user; and
the share signal is associated with a data shared by the user with one or more other users.

15. The system of claim 13, wherein the analyzer analyzes the set of signals by determining one or more keywords present in the set of signals to identify the one or more user interests.

16. The system of claim 13, wherein the available advertisement pool is maintained by an advertisement network.

17. A system for analyzing a set of signals to identify one or more user interests corresponding to a user, the system comprising:
a processor for:
identifying at least one of a webpage accessed by the user, a search query input by the user, a click performed by the user on an Uniform Resource Locator (URL) and a data shared by the user, based on an information present in the set of signals;
determining one or more keywords present in at least one of the webpage accessed by the user, the search query input by the user, the click performed by the user and the data shared by the user;
determining the one or more user interests based on the analysis of the one or more keywords; and
an analyzer for using an online information source to analyze the one or more keywords.

18. The system of claim 17, wherein the online information source is an encyclopedia website.

19. A system for identifying one or more users from a plurality of users for a predefined targeted advertisement, the system comprising:
an analyzer for analyzing a set of signals associated with one or more users of the plurality of users, wherein the set of signals comprises at least one of a share signal, a view signal, a search signal and a click signal; and
a processor for:
identifying one or more user interests for the one or more users of the plurality of users based on the analysis of the set of signals;
matching the identified one or more user interests for the one or more users with the predefined targeted advertisement; and
determining the one or more users from the plurality of users for the predefined targeted advertisement based on the matching.

20. The system of claim 19, wherein:
the view signal is associated with a web page browsed by the user;
the search signal is associated with a search query executed by the user;
the click signal is associated with a web link clicked by the user; and
the share signal is associated with a data shared by the user with one or more other users.

21. The system of claim 19, wherein the analyzer analyzes the set of signals associated with the one or more users by identifying one or more keywords present in the set of signals to identify the user interests of the one or more users.

22. A system for permitting an advertisement campaign manager to identify one or more users for targeted advertisements, the system comprising:
an online tool to allow the advertisement campaign manager to input keywords associated with the targeted advertisements;
a processor for:
using a predefined page level co-occurrence algorithm to determine one or more additional keywords related to the keywords input by the advertisement campaign manager;
providing an option to the advertisement campaign manager to select additional keywords from the determined one or more additional keywords;
determining one or more users for targeted advertisement based on the keywords input by the advertisement campaign manager and the selected additional keywords; and
a display for presenting a list of one or more users to the advertisement campaign manager, wherein the list of one or more users is divided into one or more sub-groups.

23. The system of claim 22 wherein the online tool is further configured to determine an effectiveness of the targeted advertisement based on a number of clicks performed by the one or more users for the targeted advertisement.

24. The system of claim 22, wherein the one or more sub-groups comprises at least one of a group of influencers, a group of affected users and a group of potentials.

25. A computer program product for use with a computer, the computer program product comprising a tangible computer usable medium having a computer readable program code embodied therein for providing targeted advertisements to a user, the computer program code comprising:
program instructions for determining a set of signals corresponding to at least one online activity associated with the user, wherein the set of signals comprises at least one of a share signal, a view signal, a search signal and a click signal;
program instructions for analyzing the set of signals to identify one or more user interests;
program instructions for tagging the user with at least one ad exchange cookie based on the one or more user interests and an available advertisement pool; and
program instructions for serving, by an advertisement network, an advertisement to the user based on the ad exchange cookie.

26. The computer program product of claim 25, wherein:
the view signal is associated with a web page browsed by the user;
the search signal is associated with a search query executed by the user;
the click signal is associated with a web link clicked by the user; and
the share signal is associated with a data shared by the user with one or more other users

27. The computer program product of claim 25, wherein program instructions for analyzing the set of signals comprises program instructions for determining one or more keywords present in the set of signals to identify the one or more user interests.

28. The computer program product of claim 25, wherein the available advertisement pool is maintained by the advertisement network.

29. A computer program product for use with a computer, the computer program product comprising a tangible computer usable medium having a computer readable program code embodied therein for analyzing a set of signals to identify one or more user interests corresponding to a user, the computer program code comprising:
program instructions for identifying at least one of a webpage accessed by the user, a search query input by the user, a click performed by the user on an Uniform Resource Locator (URL) and a data shared by the user, based on an information present in the set of signals;
program instructions for determining one or more keywords present in at least one of the webpage accessed by the user, the search query input by the user, the click performed by the user and the data shared by the user;
program instructions for using an online information source to analyze the one or more keywords; and
program instructions for determining the one or more user interests based on the analysis of the one or more keywords.

30. The computer program product of claim 29, wherein the online information source is an encyclopedia website.

31. A computer program product for use with a computer, the computer program product comprising a tangible computer usable medium having a computer readable program code embodied therein for identifying one or more users from a plurality of users for a predefined targeted advertisement, the computer program code comprising:
program instructions for analyzing a set of signals associated with one or more users of the plurality of users, wherein the set of signals comprises at least one of a share signal, a view signal, a search signal and a click signal;
program instructions for identifying one or more user interests for the one or more users of the plurality of users based on the analysis of the set of signals;
program instructions for matching the identified one or more user interests for the one or more users with the predefined targeted advertisement; and
program instructions for selecting users for the predefined targeted advertisement based on the matching.

32. The computer program product of claim 31, wherein:
the view signal is associated with a web page browsed by the user;
the search signal is associated with a search query executed by the user;
the click signal is associated with a web link clicked by the user; and
the share signal is associated with a data shared by the user with one or more other users.

33. The computer program product of claim 31, where program instructions for analyzing a set of signals associated with one or more users comprises program instructions for identifying one or more keywords present in the set of signals to identify the one or more user interests of the one or more users.

34. A computer program product for use with a computer, the computer program product comprising a tangible computer usable medium having a computer readable program code embodied therein for allowing an advertisement campaign manager to identify one or more users for targeted advertisements, the computer program code comprising:
program instructions for providing an online tool to the advertisement campaign manager to permit the advertisement campaign manager to input keywords associated with the targeted advertisements;
program instructions for using a predefined page level co-occurrence algorithm to determine one or more additional keywords related to the keywords input by the advertisement campaign manager;
program instructions for providing an option to the advertisement campaign manager to select additional keywords from the determined one or more additional keywords;
program instructions for determining one or more users for targeted advertisement based on the keywords input by the advertisement campaign manager and the selected additional keywords; and
program instructions for presenting a list of one or more users to the advertisement campaign manager, wherein the list of one or more users is divided into one or more sub-groups

35. The computer program product of claim 34, further comprising program instructions for using the online tool to determine an effectiveness of the targeted advertisement based on a number of clicks performed by the one or more users for the targeted advertisement.

36. The computer program product of claim 34, wherein the one or more sub-groups comprises at least one of a group of influencers, a group of affected users and a group of potentials.
